(19) United States
(12) Patent Application Publication
(10) Pub. No.: US 2008/0274348 A1
(43) Pub. Date: Nov. 6, 2008

(54) Method for Producing Coating Film Using Aerosol, Fine Particles for Use Therein, and Coating Film and Composite Material

(76) Inventors: Junichi Iwasawa, Fukuoka-ken (JP); Hironori Hatono, Fukuoka-ken (JP); Hiroaki Ashizawa, Fukuoka-ken (JP)

Correspondence Address: LADAS & PARRY LLP, 26 WEST 61ST STREET, NEW YORK, NY, 10023, US

(21) Appl. No.: 11/547,509

(22) PCT Filed: Mar. 18, 2005
(86) PCT No.: PCT/JP2005/005007

§ 371 Date: Sep. 29, 2006

(30) Foreign Application Priority Data
Mar. 31, 2004 (JP) 2004-107047

(51) Int. Cl. B32B 5/16; B05D 7/00; B32B 18/00

(52) U.S. Cl. 428/325; 427/180; 428/402; 428/323

(57) ABSTRACT

There is disclosed a method for producing a film with use of aerosol which is capable of forming a film of satisfactory quality at an extremely high film formation rate. In the method, first, a carrier gas is mixed into fine particles comprising a brittle material as a main component and having a 50% average particle diameter of 100 nm to 300 nm on a number basis to form an aerosol. The aerosol is ejected onto the surface of a substrate to make the fine particles come into collision with the substrate, so that the collision crushes or deforms the fine particles to form a film on the substrate.

### BACKGROUND OF THE INVENTION

1. Field of the Invention

This invention relates to a method for producing a film of ceramics, semiconductors and the like by use of aerosol, fine particles used in the method, and a film and a composite material obtained by the method.

2. Background Art

A method for forming a film by use of aerosol, which is called an aerosol deposition method, has been recently proposed as a new technique for forming a film of ceramics and the like. In this method, an aerosol containing fine particles of a brittle material such as ceramics is formed. The aerosol is then ejected onto the surface of a substrate to make the fine particles come into collision with the substrate, so that the collision crushes or deforms the fine particles to form a film on the substrate. According to the method, a dense-ceramics thick film exhibiting a high hardness and having a thickness of 1 μm to several hundred μm is able to be formed at room temperature directly on the surface of the substrate of metal, ceramics, a glass material or the like. It has been said that the formation of such a thick film is difficult with the use of a conventional film forming method, for example, sol-gel method, CVD, or PVD.

A known method for obtaining a compact film in a high density uses, as a material for fine particles used for aerosol, brittle-material fine particles in which internal strains are applied, to facilitate deformation or fracture of the fine particles when they come into collision with the substrate (see WO01/27348, for example).

Further, a known method for obtaining a dense film at low temperatures uses, as a material for fine particles used for aerosol, a combination of fine particles for crushing having an average particle diameter of 0.5 μm to 5 μm and brittle-material fine particles having an average particle diameter of 10 nm to 1 μm (see JP-A-2001-3180, for example).

Still further, a known method for obtaining a dense film exhibiting a high hardness uses, as a material for fine particles used for aerosol, alumina particles having an average particle diameter of 0.1 μm to 5 μm and having an O/Al ratio higher than the stoichiometric composition to form a film (see JP-A-2002-206179, for example).

### SUMMARY OF THE INVENTION

The present inventors have now found that a film with a satisfactory quality can be formed at an extremely high film formation rate by impacting and depositing, onto and on a substrate, aerosol formed by the use of fine particles having a 50% average particle diameter (D50) of 100 nm to 300 nm on a number basis.

Accordingly, it is an object of the present invention to provide a method for producing a film with use of aerosol which is capable of forming a film of satisfactory quality at an extremely high film formation rate.

A method for producing a film by use of aerosol of the present invention comprises:

mixing fine particles with a carrier gas to form the aerosol, wherein the fine particles comprise a brittle material as a main component and have a 50% average particle diameter (D50) of 100 nm to 300 nm on a number basis;

ejecting the aerosol onto a surface of a substrate to make the fine particles come into collision with the substrate, the collision crushing or deforming the fine particles to form a film on the substrate.

Also, fine particles of the present invention are those used as a material for the film in the above method, wherein the fine particles comprise a brittle material as a main component and have a 50% average particle diameter (D50) of 100 nm to 300 nm on a number basis.

Further, according to the present invention, there is provided a film produced by the foregoing method.

Furthermore, according to the present invention, there is provided a composite material comprising a substrate and a film formed on the substrate and produced by the foregoing method.

### BRIEF DESCRIPTION OF THE DRAWINGS

FIG. 1 is a diagram illustrating an example of a film producing apparatus used in a method of the present invention.

FIG. 2 is a graph showing a relationship between a 50% average particle diameter on a number basis and a film formation rate (μm·cm/min.), which is obtained in Example 2.

### DETAILED DESCRIPTION OF THE INVENTION

### Definition

In the present invention, “a 50% average particle diameter on a number basis (D50)” refers to a diameter of particles when the cumulative number of fine particles counted from the smaller particle diameter side reaches 50% in the particle-size distribution measurement data measured by the use of a dynamic light scattering type particle-size distribution instrument.

In the present invention, “particles” means primary particles, and are distinguished from powder in which primary particles are naturally agglomerated.

Method for Producing a Film by Use of Aerosol

The method for forming a film according to the present invention can be carried out in accordance with an aerosol deposition method or a method which is called the Ultra-Fine particles beam deposition method. Therefore, the method according to the present invention has substantially the same basic principle as that of the method described in WO01/27348, for example, the disclosure of which is incorporated into a part of the disclosure of the present specification. If the disclosure of this publication and the disclosure described below differ from each other, it is needless to say that the following description is paramount and its contents are the present invention.

In the method of the present invention, first of all, there are provided fine particles comprising a brittle material as a main component and having a 50% average particle diameter (D50) of 100 nm to 300 nm on a number basis. In addition, the fine particles are mixed with a carrier gas to form an aerosol. Then, the aerosol is ejected onto the surface of a substrate so as to make the fine particles come into collision with the substrate, while the fine particles are crushed or deformed by the collision to form a film on the substrate. In the present invention, by the use of fine particles having the aforementioned average particle diameter, the formation of the film of a satisfactory quality, such as in the hardness, density and the like, at an extremely high film formation rate can be achieved.

In the method according to the present invention, the formation of a film by collision of fine particles with a substrate is considered as described below. However, the following description is just an assumption and the present invention is not at all limited to the assumption. First, because ceramics are in an atomic bond state of showing strong ionic bonding properties or strong covalent boding properties having few free electrons, the ceramics have properties of having a high hardness and low impact resistance. A semiconductor such as silicon or germanium is also a brittle material having no ductility. Accordingly, when a mechanical impact is added to such a brittle material, displacement or deformation of a crystal lattice can occur along a cleavage face on an interface between crystals or the like or the brittle material can be crushed. When the phenomena occur, a new surface is created on the displaced face or the fracture face. The new surface originally exists inside the fine particle and is a face having an exposure of an atom which has bonded to another atom. A part of the new surface corresponding to an atom layer is exposed to a surface state which is forcibly made unstable by an external force from the originally stable atomic bonding state, resulting in a state of a high surface energy. Then, the active surface joins the surface of an adjacent brittle material, a new surface of the same adjacent brittle material, or the substrate surface so as to become a stable state. At this point, it is considered that, in the boundary area with the substrate, a part of the re-bonding fine particles bite into the substrate surface to form an anchor portion, and films formed of the poly crystal brittle material are deposited on the anchor portion. It is considered that the continuous application of the mechanical impact force from the external induces sequential occurrence of the aforementioned phenomena and the bond is developed by the repeated deformation and crushing of the fine particles, leading to an increase in density of the formed structure.

According to a preferred embodiment of the present invention, it is preferred that, in the film according to the present invention obtained as described above, the crystals, which are poly crystals and form a film, do not substantially have a crystal orientation, that a grain boundary layer formed of a vitreous material does not substantially exist on the interface between crystals, and that a part of the film forms an anchor portion biting into the substrate surface. Such a film can be a dense-ceramic thick film having a high hardness, superior wear resistance and substrate adhesion properties as well as a high breakdown voltage.

Fine Particles

The fine particles in the present invention comprise a brittle material as the main component. As long as the brittle material used in the present invention has properties of being deposited as a film on a substrate by being crushed or deformed when the brittle material as the fine particle aerosol is ejected onto the surface of the substrate, the brittle material used in the present invention is not particularly limited, and various material can be used, in the case of which a nonmetallic inorganic material is desirable. In this connection, the crushing and deformation can be determined when, in a crystallite size measured and calculated by a Scherrer method using X-ray diffraction, a crystallite size of the film is smaller than a crystallite size of the raw fine particles.

According to the preferred embodiment of the present invention, it is preferred that the nonmetallic inorganic material is at least one selected from the group consisting of an inorganic oxide, inorganic carbide, inorganic nitride, inorganic boride, a multi-component solid solution thereof, ceramics and semiconductor materials. Examples of inorganic oxide include an aluminum oxide, titanium oxide, zinc oxide, tin oxide, iron oxide, zirconium oxide, yttrium oxide, chromium oxide, hafnium oxide, beryllium oxide, magnesium oxide, silicon oxide and the like. Examples of inorganic carbide include diamond, boron carbide, silicon carbide, titanium carbide, zirconium carbide, vanadium carbide, niobium carbide, chromium carbide, tungsten carbide, molybdenum carbide, tantalum carbide, and the like. Examples of inorganic nitride include boron nitride, titanium nitride, aluminum nitride, silicon nitride, niobium nitride, tantalum nitride and the like. Examples of inorganic boride include boron, aluminum boride, silicon boride, titanium boride, zirconium boride, vanadium boride, niobium boride, tantalum boride, chromium boride, molybdenum boride, tungsten boride, and the like. Examples of ceramics include piezoelectric or pyroelectric ceramics, such as barium titanate, lead titanate, lithium titanate, strontium titanate, aluminum titanate, PZT, PLZT; high-toughness ceramics, such as sialon, cermet; biocompatible ceramics, such as mercury apatite, calcium phosphate; and the like. Examples of semiconductor materials include semiconductor materials where various dopants such as phosphorus are added into silicon, germanium or both of them; semiconductor compounds such as gallium arsenide, indium arsenide, cadmium sulfide; and the like. Further, according to another preferred embodiment of the present invention, it is possible to use an organic material having brittleness such as rigid vinyl chloride, polycarbonate, and acrylic.

According to a preferred embodiment of the present invention, it is possible to use a mixture of fine particles of two or more types of brittle materials as the fine particles. As a result, a film of composition and structure, not easily formed by a conventional method, is able to be easily formed, which makes it possible to realize a new type film and a new type composite material which are not be realized conventionally.

Further, the fine particle used in the present invention has a 50% average particle diameter (D50) of 100 nm to 300 nm, preferably 150 nm to 290 nm, more preferably 180 nm to 250 nm, on a number basis. By use of the fine particle having the aforementioned average particle diameter, the formation of a film of a satisfactory film quality at an extremely high film formation rate can be achieved.

Substrate

The substrate used in the method according to the present invention is not limited as long as the material has the hardness having the degree to which a sufficient mechanical impact force for crushing or deforming the fine particle material can applied to the material by ejecting an aerosol onto the substrate to lead to the collision of the particle mixture. Preferred examples of substrates include glass, metal, ceramics, semiconductors, or organic compounds, and composite materials thereof.

Manufacturing of a Film and an Apparatus Therefor

In the method according to the present invention, a carrier gas is mixed into the aforementioned fine particles to form an aerosol. The aerosol in the present invention is an aerosol in which fine particles are dispersed in a carrier gas, which is desirably in a state of dispersing primary particles but may contain aggregated granules resulting from aggregation of the primary particles. A commercially available aerosol generator is used to form the aerosol in accordance with a well-known method. At this point, the fine particles of the present invention may be fed into the aerosol generator in advance, may be mixed with the carrier gas in the middle of a pipe extending from the aerosol generator to nozzle, or alternatively may be mixed with the carrier gas in a position between the nozzle and the substrate immediately before the carrier gas reaches the substrate. The carrier gas is not particularly limited as long as it is inactive with the fine particles and also does not adversely affect the composition of the film. Preferred examples of carrier gases include nitrogen, helium, argon, oxygen, hydrogen, dry air and a mixture gas thereof.

According to a preferred embodiment of the present invention, types and/or partial pressures of the carrier gas can be controlled in order to control composition in the film or control the atomic configuration. In this way, the electric characteristics, mechanical characteristics, chemical characteristics, optical characteristics, magnetic characteristics and the like of the film can be controlled.

In the method according to the present invention, the aerosol is ejected onto the surface of the substrate to make the fine particles collide with the substrate, so that the collision crushes or deforms the fine particles to form a film on the substrate. The temperature conditions on this process may be determined appropriately, but this process can be performed at a remarkably lower temperature than a general sintering temperature of ceramics, for example, 0° C. to 100° C., typically at room temperature.

According to a preferred embodiment of the present invention, ejecting the aerosol onto the substrate is preferably performed by ejecting the aerosol from a nozzle, more preferably by ejecting the aerosol from a nozzle while the nozzle is moved relatively to the substrate, that is, by ejecting the aerosol while the nozzle is scanned on the substrate. A film formation rate on this process is preferably 1.0 μm·cm/min. or more, more preferably 1.2 μm·cm/min. or more, furthermore preferably 1.4 μm·cm/min. or more, most preferably 1.6 μm·cm/min. or more. Further, according to a preferred embodiment of the present invention, a ejecting rate of the aerosol is preferable within a range from 50 m/s to 450 m/s, more preferable within a range from 150 m/s to 400 m/s. As a result of setting such a range, the new surfaces are apt to be formed when the fine particles come into collision with the substrate, superior film formation properties are achieved, and the film formation rate is increased.

According to a preferred embodiment of the present invention, the thickness of the film is preferably 0.5 μm or more, more preferably 1 μm to 500 μm, furthermore preferably 3 μm to 100 μm. As described above, according to the method of the present invention, it is possible to form a thicker film as compared with other film-forming methods such as a PVD method, a CVD method, and a sol-gel method.

According to a preferred embodiment of the present invention, the film is preferably formed under a reduced pressure. In this way, the activity of the new surfaces formed in the fine particles can be retained for a certain period of time.

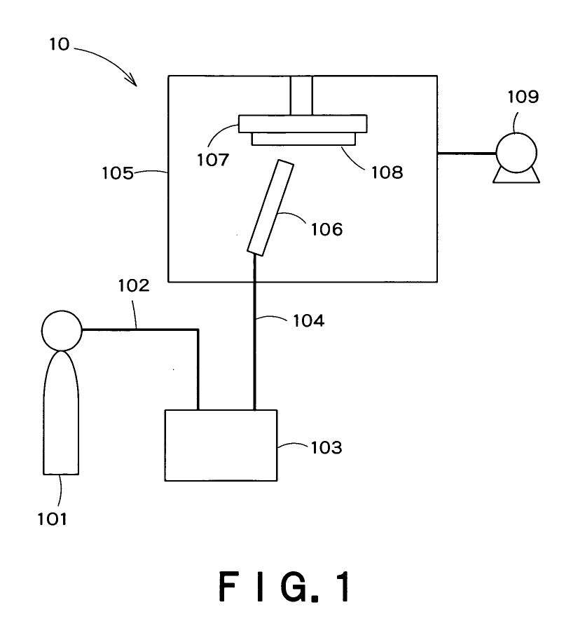

FIG. 1 shows an example of a film producing apparatus for carrying out the method of the present invention. A producing apparatus 10 shown in FIG. 1 has a nitrogen gas tank 101 connected through a gas carrier pipe 102 to an aerosol generator 103 storing aluminum oxide fine particles, and through an aerosol carrier pipe 104 to a nozzle 106 which is mounted in a forming chamber 105 and has an opening of 0.4 mm vertical and 17 mm horizontal. A metal substrate of various types 108 placed on an XY stage 107 is mounted in front to the leading end of the nozzle 106, and the forming chamber 105 is connected to a vacuum pump 109.

An example of the film producing method using the producing apparatus 10 will be described below. The nitrogen gas tank 101 is opened to introduce a high-purity nitrogen gas through the gas carrier pipe 102 to the aerosol generator 103, in order to generate an aerosol in which the aluminum oxide fine particles and the high-purity nitrogen gas are mixed. The aerosol is conveyed through the aerosol carrier pipe 104 to the nozzle 106, and then is ejected at high speed from the opening of the nozzle 106. The aerosol ejected from the nozzle 106 comes into collision with the metal substrate 108 and forms a film at the collision region. Then, the XY stage 107 is operated to move the metal substrate 108 back and forth to form a film in a predetermined area. The film forming can be performed at room temperature.

### EXAMPLES

The present invention will be described in more detail in the following examples. It should be noted that the present invention is not limited to these examples.

### Example 1

### Preparation of Fine Particles

Five types of commercially available aluminum oxide fine particles were provided. The 50% average particle diameter of the fine particles on a number basis was measured as described below. First, 0.002 g of the aluminum oxide fine particles and 30 ml of a 0.2% sodium hexametaphosphate solution by weight were put into a beaker, and then were irradiated for 15 minutes with the supersonic wave (80W). Thereafter, this solution was put into a transparent cell for measuring a particle size distribution by a dynamic scattering particle size distribution measuring instrument (Zetasizer 3000HS produced by Malvern Co.). As a result, the 50% average particle diameters of the fine particles of five types on a number basis were as follows.

Sample 1: 51.4 nm

Sample 2: 181.7 nm

Sample 3: 205.7 nm

Sample 4: 390.9 nm

Sample 5: 580.1 nm

Next, Sample 3 and Sample 4 were mixed together at the weight ratio of 1:1 to obtain Sample 6. Sample 3 and Sample 4 were mixed together at the weight ratio of 1:2 to obtain Sample 7. Sample 3 and Sample 4 were mixed together at the weight ratio of 1:3 to obtain Sample 8. The 50% average particle diameters of Samples 6 to 8 on a number basis were measured in the same way as the above and the following results were obtained.

Sample 6: 245.5 nm

Sample 7: 289.2 nm

Sample 8: 333.7 nm

There were thus obtained eight kinds of Samples 1 to 8 having different 50% average particle diameters on a number basis.

### Example 2

### Producing a Film Using Aerosol

Samples 1 to 8 of the aluminum oxide fine particles obtained in Example 1 are used to produce a film as described below. The sample obtained in Example 1 was fed into the aerosol generator 103 of the forming apparatus 10 shown in FIG. 1. Then, while a helium gas as a carrier gas was flowing through the apparatus at a flow rate of 7 L/min., an aerosol was generated, which was then ejected onto a stainless (SUS) substrate. Thus, an aluminum oxide film of the forming area 10 mm×17 mm was formed on the substrate.

The thickness of the formed aluminum oxide film was measured by the use of a stylus-type surface profile measuring instrument (produced by Nippon Shinkuu Gijutu Corporation, Decktak3030), thereby calculating the forming rate of the aluminum oxide film (μm·cm/min.). The film formation rate (μm·cm/min.) means the thickness (μm) of the film formed for every 1 cm of a scanning distance for one minute.

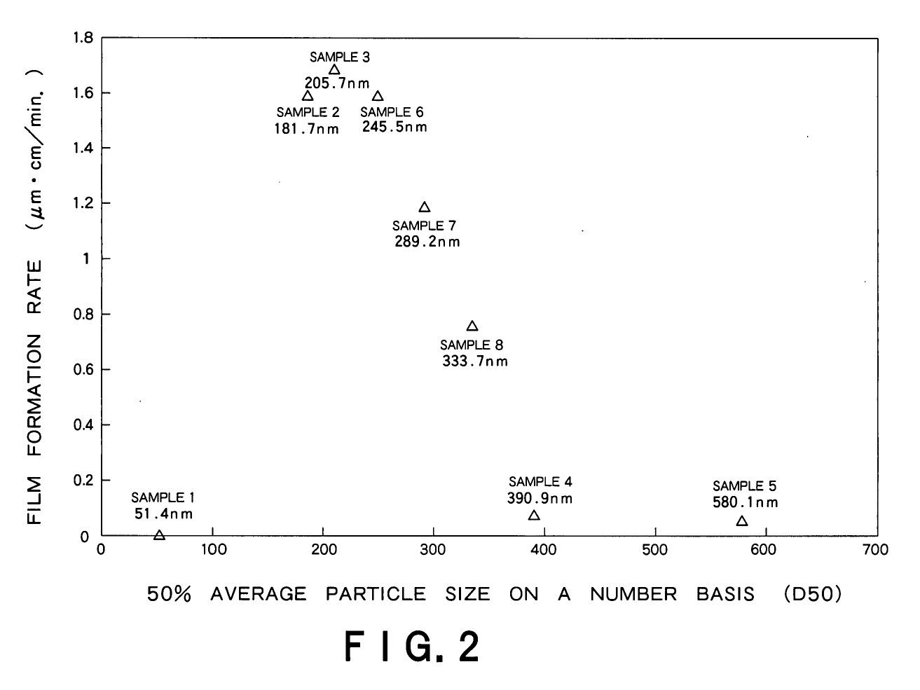

The film formation rates measured on Samples 1 to 8 are shown in FIG. 2. As shown in FIG. 2, it is seen that the film formation rate significantly increases in the range of 100 nm to 300 nm, particularly 150 nm to 290 nm, of the 50% average particle diameter on a number basis.

The Vickers hardness of the film formed by use of each of Samples 2 and 3 were measured by the use of a dynamic ultra-micro hardness tester (DHU-W201, Shimadzu Seisakusho). As a result, the Vickers hardness of the film formed by use of each of Samples 2 and 3 respectively was HV800. As a result, according to the manufacturing method, it is seen that a film having a good quality, particularly high hardness, can be formed at an extremely high film formation rate.

1. A method for producing a film by use of aerosol, the method comprising:
mixing fine particles with a carrier gas to form an aerosol, wherein the fine particles comprise a brittle material as a main component and have a 50% average particle diameter (D50) of 100 nm to 300 nm on a number basis;
ejecting the aerosol onto a surface of a substrate to make the fine particles come into collision with the substrate, the collision crushing or deforming the fine particles to form a film on the substrate.

2. A method according to claim 1, wherein the fine particles have a 50% average particle diameter (D50) of 150 nm to 290 nm on a number basis.

3. A method according to claim 1, wherein the fine particles have a 50% average particle diameter (D50) of 180 nm to 250 nm on a number basis.

4. A method according to claim 1, wherein the brittle material is a nonmetallic inorganic material.

5. A method according to claim 4, wherein the nonmetallic inorganic material is at least one selected from the group consisting of an inorganic oxide, inorganic carbide, inorganic nitride, inorganic boride, a multi-component solid solution, ceramics and a semiconductor material.

6. A method according to claim 1, wherein the fine particles are a mixture of fine particles of the two or more types of the brittle materials.

7. A method according to claim 1, wherein the substrate comprises at least one selected from the group consisting of glass, metal, ceramics, a semiconductor, and an organic compound.

8. A method according to claim 1, wherein the carrier gas contains at least one selected from the group consisting of nitrogen, helium, argon, oxygen, hydrogen, and dry air.

9. A method according to claim 1, wherein a forming rate of the film is 1.0 μm·cm/minute or more.

10. Fine particles used as a material for the film in the method according to claim 1, wherein the fine particles comprise a brittle material as a main component and have a 50% average particle diameter (D50) of 100 nm to 300 nm on a number basis.

11. Fine particles according to claim 10, having a 50% average particle diameter (D50) of 150 nm to 290 nm on a number basis.

12. Fine particles according to claim 10, having a 50% average particle diameter (D50) of 180 nm to 250 nm on a number basis.

13. Fine particles according to claim 10, wherein the brittle material is a nonmetallic inorganic material.

14. Fine particles according to claim 13, wherein the nonmetallic inorganic material comprises at least one selected from the group consisting of an inorganic oxide, inorganic carbide, inorganic nitride, inorganic boride, a multi-component solid solution, ceramics and a semiconductor material.

15. Fine particles according to claim 10, comprising a mixture of fine particles of the two or more types of the brittle materials.

16. A film produced by the method according to claim 1.

17. A film according to claim 16, wherein the film substantially comprises poly crystals.

18. A film according to claim 16, having substantially no grain boundary layer formed of a vitreous material.

19. A composite material comprising:
a substrate; and
a film according to any one of claim 16 formed on the substrate.

20. A composite material according to claim 19, wherein the substrate comprises at least one selected from the group consisting of glass, metal, ceramics, a semiconductor, and an organic compound.

21. A composite material according to claim 19, wherein the fine particles bite into the surface of the substrate to form an anchor portion.
